(19) United States
(12) Patent Application Publication
(10) Pub. No.: US 2016/0352389 A1
(43) Pub. Date: Dec. 1, 2016

(54) POWERLINE ADAPTER AND METHOD

(71) Applicants: Chee Yee Chong, Los Altos, CA (US); George Lee, Los Altos, CA (US)

(72) Inventors: Chee Yee Chong, Los Altos, CA (US); George Lee, Los Altos, CA (US)

(21) Appl. No.: 14/722,063

(22) Filed: May 26, 2015

(51) Int. Cl. H04B 3/56; H04N 7/18; H04N 7/10

(52) U.S. Cl. CPC H04B 3/56; H04N 7/102; H04N 7/183

(57) ABSTRACT

A power-line adaptor comprising a communication interface configured to provide bidirectional communication with a camera via a communication connector and a power interface coupled to the communication interface and configured to connect to a power line via a power-line connector, the power interface being further configured to transmit data received from the camera via the communication interface over the power line and to transmit data received over the power line to the camera via the communication interface.

### BACKGROUND

Surveillance cameras are frequently used to deter crime and to document unwanted trespass upon private or business property. Unfortunately, surveillance cameras require costly and complex wiring to transmit video feeds and the vast majority of homes and properties do not have the necessary wiring for surveillance in place.

One technique for transmitting footage from a surveillance camera without the necessary complex wiring would be to transmit the data over a wireless network. However, there are multiple drawbacks to this approach. Wireless communication can be unreliable and insecure. Additionally, the transfer of large amounts of data over wireless communication would monopolize a user's home network and bandwidth.

Accordingly, alternative technologies for transmitting video and camera footage from a camera are needed.

### BRIEF DESCRIPTION OF THE DRAWINGS

FIG. 1 illustrates a power-line adapter according to an exemplary embodiment.

FIG. 2 illustrates a power-line connector having an Edison base.

FIG. 3 illustrates a power-line connector having a two wire connector.

FIG. 4 illustrates another power-line adapter according to an exemplary embodiment.

FIG. 5 illustrates additional features of the power-line adapter according to an exemplary embodiment.

FIGS. 6A-6B illustrate examples of the power-line adapter according to an exemplary embodiment.

FIG. 7 illustrates a flowchart for transmitting surveillance-related data over a power line according to an exemplary embodiment.

FIG. 8 illustrates a system chart of collection components and display components according to an exemplary embodiment.

FIG. 9 illustrates an exemplary computing environment that can be used to carry out the method for transmitting surveillance-related data over a power line according to an exemplary embodiment.

### DETAILED DESCRIPTION

While devices, adapters, methods, apparatuses, and computer-readable media are described herein by way of examples and embodiments, those skilled in the art recognize that devices, adapters, methods, apparatuses, and computer-readable media for transmitting camera data over a power-line are not limited to the embodiments or drawings described. It should be understood that the drawings and description are not intended to be limited to the particular form disclosed. Rather, the intention is to cover all modifications, equivalents and alternatives falling within the spirit and scope of the appended claims. Any headings used herein are for organizational purposes only and are not meant to limit the scope of the description or the claims. As used herein, the word “may” is used in a permissive sense (i.e., meaning having the potential to) rather than the mandatory sense (i.e., meaning must). Similarly, the words “include,” “including,” and “includes” mean including, but not limited to.

The Applicant has discovered devices and methods to efficiently transmit data to and from a camera which utilize the wiring of existing light fixtures and electrical connections. These devices and methods effectively eliminating the need for additional wiring and allow for high speed transfer of camera data over existing power lines.

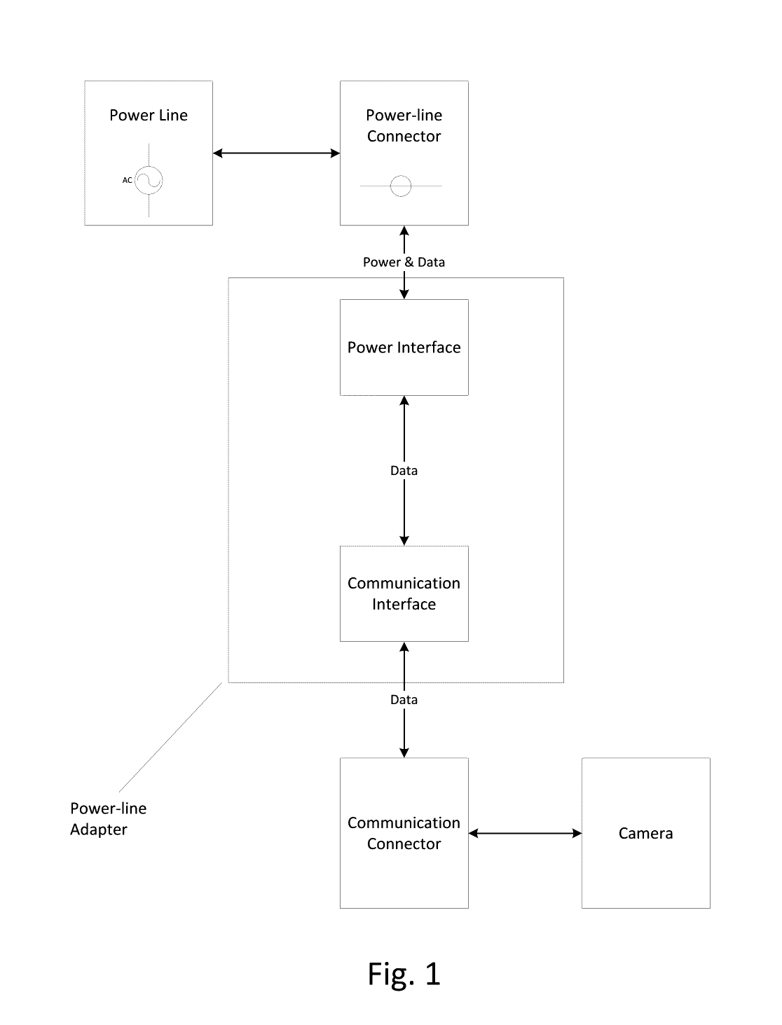

FIG. 1 illustrates a power-line adapter according to an exemplary embodiment. As shown in the figure, the power-line adapter includes a communication interface configured to provide bidirectional communication with a camera via a communication connector. The communication connector allows for the transfer of data (such as camera instructions and commands) to the camera from the communication interface and the transfer of data (such as video feeds and images) from the camera to the communication interface. Therefore, the camera is communicatively coupled to the power-line adapter.

The camera can be any type of camera or video-camera and can incorporate a variety of features. For example, the camera can have a 2.8 mm wide view, a fisheye 360 degree view, high definition (HD) image capture and video capture (such as HD 3 Megapixel 24 frames-per-second quality), infra-red night vision, and/or motion light assisted illumination.

The power-line adapter also includes a power interface coupled to the communication interface and configured to connect to a power line via a power-line connector. The power interface is also configured to transmit data received from the camera via the communication interface over the power line through the power-line connector. Additionally, the power interface is configured to transmit data that is received over the power line (through the power-line connector) to the camera via the communication interface (and the communication connector).

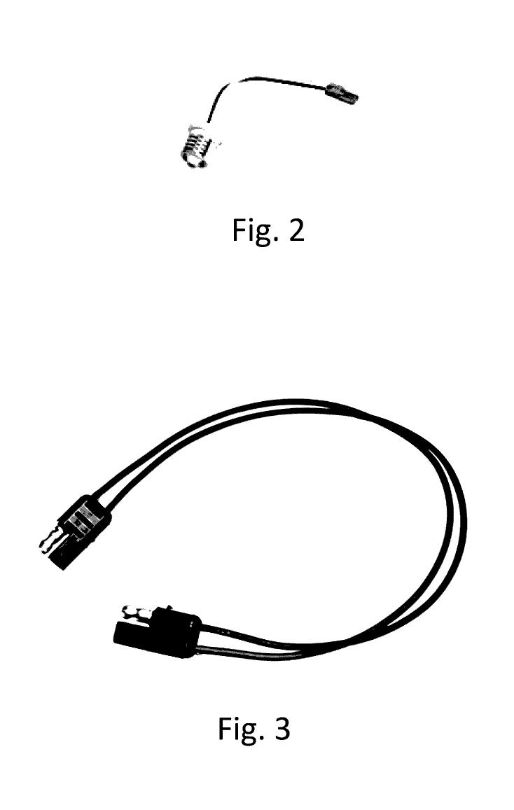

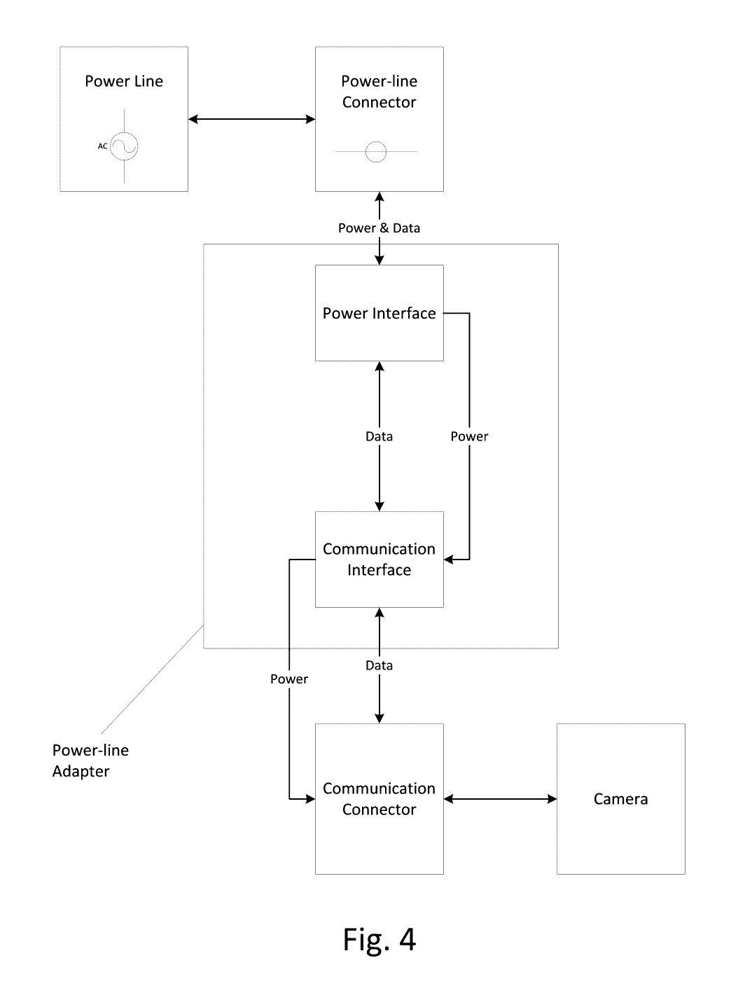

The power-line connector used to connect the power interface of the power-line adapter to the power line can take a variety of forms. As shown in FIG. 2, the power-line connector can have an Edison base on one end and a two wire connector on the other end which mates with the power interface of the power-line adapter. In this case, the power-line connector can screw into any common light socket to access the power line. Additionally, as shown in FIG. 3, the power-line connector can also have two wire connectors on both ends, one of which mates with a power line outlet and another which mates with the power interface of the power-line adapter.

Returning to FIG. 1, the power interface receives power and data from the power-line over the power-line connector and transmits power and data over the power line through the power-line connector. The power interface can also send data to the communication interface. The power interface is thereby configured to transmit data received by the power-line adapter over the power-line to the camera. For example, a user may provide data including one or more instructions or commands for the camera at a computing device which is communicatively coupled to the power line. The data can then be transferred over the power line and received at the power interface through the power-line connector. This data can then be forwarded by the power interface to the communication interface and then through the communication connector to the camera (or a computing device located within the camera or coupled to the camera), where the instructions or commands can be parsed and/or executed.

The communication interface can receive data from the camera through the communication connector. The communication interface can also send this data to the power interface which can then transmit the data through the power-line connector and over the power line. For example, data including a surveillance feed (such as video and/or images) can be transmitted from the camera to the communication interface and from the communication interface to the power interface. The data can then be transmitted by the power interface through the power-line connector and over power line. The power interface can thereby transmit data received by the power-line adapter from the camera over the power line. On the receiving end, a computing device communicatively coupled to the power line can receive the data and display the surveillance feed to a user on a suitable display device. Alternatively, the data can be received and displayed by a display device communicatively coupled to the power line.

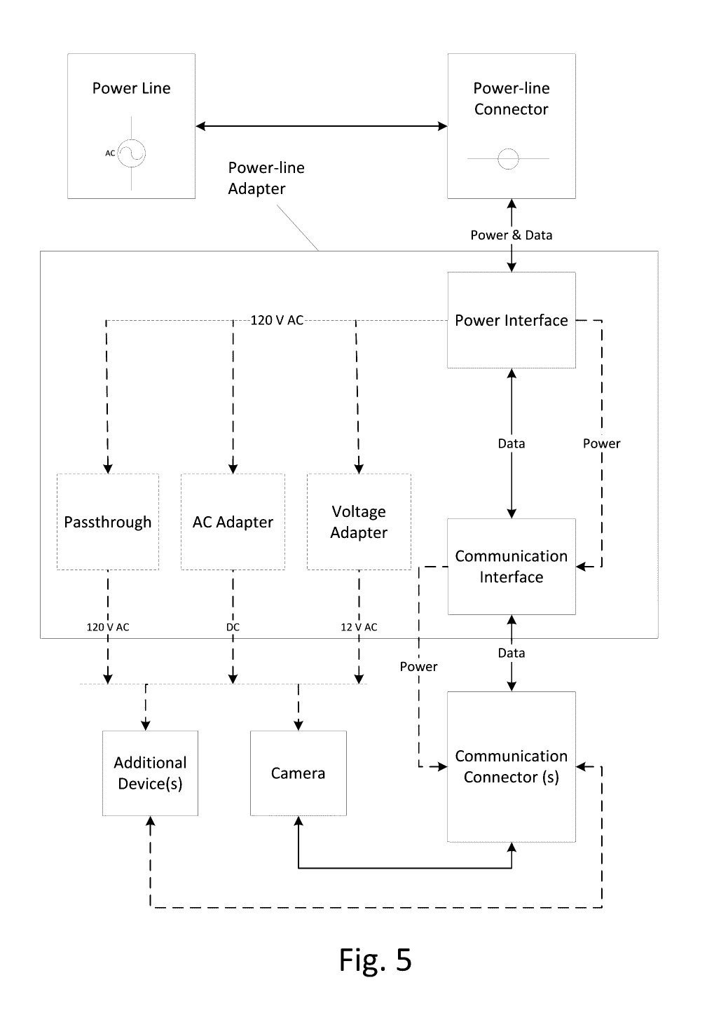

FIG. 4 illustrates another power line adapter according to an exemplary embodiment. The power line adapter of FIG. 4 incorporates all of the features discussed with reference to FIG. 1 and adds some additional features and aspects.

Similar to the power interface of FIG. 1, the power interface in FIG. 4 is configured to send data to the communication interface and to receive data from the communication interface. However, the power interface of FIG. 4 is also configured to transmit power to the communication interface. The power and data connections between the power interface and communication interface in FIG. 4 are shown as two separate directional arrows to indicate that the power flows in one direction while the data flows in two directions, but of course the power and data can be transmitted over a single connection.

The communication interface, in turn, is configured to provide power to the camera via the communication connector (in addition to having bidirectional communication with the camera). Once again, the power and data connections between the communication interface and the communication connector in FIG. 4 are shown as two separate directional arrows to indicate that the power flows in one direction while the data flows in two directions, but of course the power and data can be transmitted over a single connection. In this case, the communication connector can be one that transmits both data and power, such as a power-over-ethernet connector.

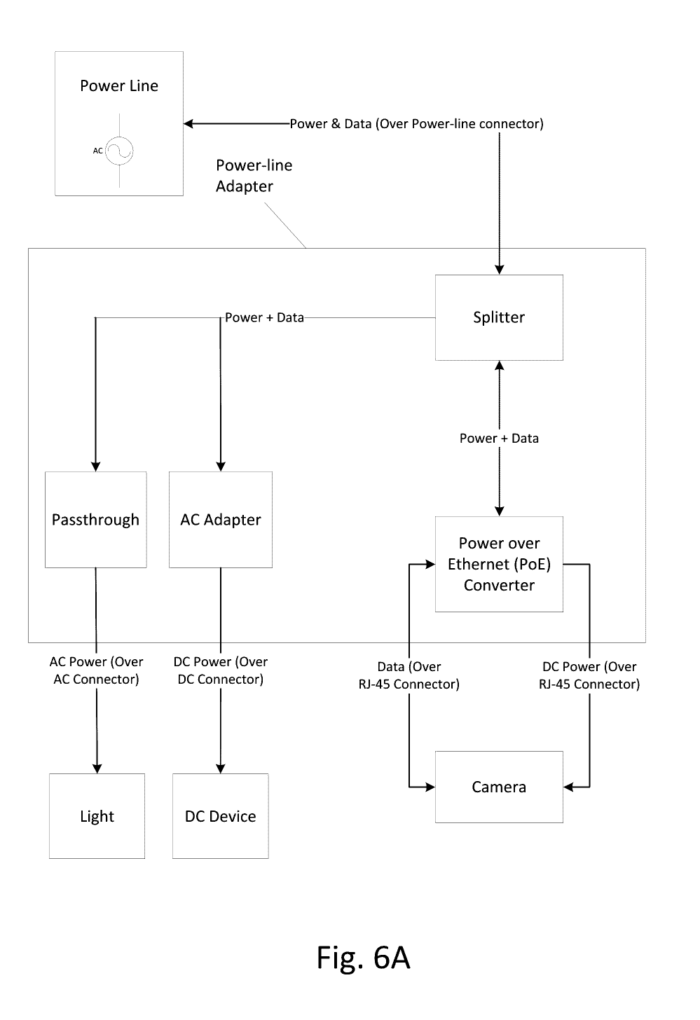

FIG. 5 illustrates additional features of the power-line adapter according to an exemplary embodiment. As shown in the figure, the communication interface of the power-line adapter receives data from the power interface and can also receive power from the power interface (indicated by the dashed arrow). The communication interface can then transmit data (and optionally power) to the camera via the communication connector.

The communication interface can also transmit data (and optionally power) to one or more additional devices via one or more additional communication connectors. In this case, the communication interface will also receive data from the one or more additional devices via the one or more additional communication connectors.

The one or more additional devices can include a motion sensor or trigger, a light, a speaker, a microphone, or any other device which can be used in conjunction with the camera. For example, if the additional devices include a motion sensor, then data from that motion sensor can be transmitted through a communication connector to the communication interface.

The motion sensor or trigger can be a motion based trigger which detects any movement with a particular area or field of view and triggers an alert message or response. The trigger can also be a schedule trigger which activates or initiates some action or alert based on some predefined schedule (for example, a schedule trigger to activate lights or monitoring a predetermined time every day).

The light can be any type of light, such as a light-emitting diode, and include a variety of customizable options. For example, the light can have color temperatures in the range from 2700K-6000K, the light can have colored red-green-blue components, the light can be dimmable, and/or the light can be configured to flash, such as in response to an alert or some intrusion detection.

Additionally, the one or more additional devices can be integrated with the camera or a housing of the camera. For example, an outdoor integrated device can include a motion sensor light with a surveillance camera or sconce with a motion sensor and surveillance camera. Similarly, an indoor integrated device can include a 6 inch recessed light with surveillance camera or a 4 inch recessed light with surveillance camera.

The power-line adapter of FIG. 5 can also include a passthrough coupled to the power interface and configured to provide power from the power line to the camera and/or to one or more additional devices, such as a motion sensor and/or a light. As shown in the figure, the passthrough allows the power from the power line to pass through the power-line adapter at the same voltage and be routed to the camera and/or the one or more additional devices.

Also shown in FIG. 5 is an alternating current (AC) adapter which can be part of the power-line adapter. The AC adapter can be coupled to the power interface and configured to provide power to the camera and/or to one or more additional devices, such as a motion sensor and/or a light. Unlike the passthrough, the AC adapter converts the alternating current received from the power line to direct current (DC) prior to routing it to the camera and/or to the one or more additional devices.

Additionally, FIG. 5 illustrates a voltage adapter which can also be part of the power-line adapter. The voltage adapter can be coupled to the power interface and configured to convert an input voltage associated with the power line to an output voltage. The voltage adapter can then be configured to provide power at the output voltage to the camera and/or to one or more additional devices, such as a motion sensor and/or a light.

The power interface can include a splitter which can be used to split the power and data signal received over the power-line connector and provide power and/or data to one or more of the passthrough, the AC adapter, the voltage adapter, and the communication interface.

Of course, the components of the power-line adapter can be used in a variety of configurations and combinations, and these examples are not intended to be limiting. Additionally, some components may contain parts of other components. For example, the voltage adapter can include an AC adapter to first transform the high voltage DC power to AC before transforming it into lower voltage DC power. Furthermore, many of the components shown in FIGS. 1, 4, and 5 can be combined to form a power-line apparatus, such as an apparatus including a power-line adapter and a camera.

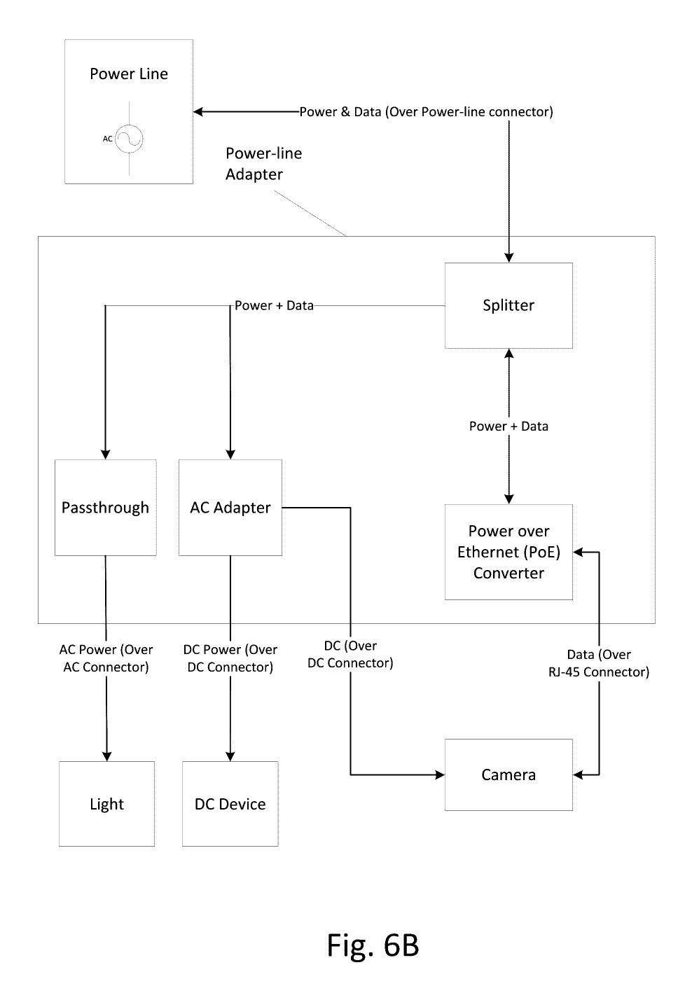

FIG. 6A illustrates an example of a power-line adapter according to an exemplary embodiment. As shown in FIG. 6A, a power-line connector is used to couple a power line to a splitter. The power-line connector can be any of the power-line connectors discussed herein, such as an Edison base connector which screws into a light socket or a two-wire connector. In this example, the power interface is the interface of the splitter which couples with the power-line connector.

As shown in FIG. 6A, the power and data signal (which is an AC signal from the power line) can then be split by the splitter into multiple signals which are transmitted from one or more interfaces of the splitter opposite the interface which received the power-line connector. One of these signals can be sent to a passthrough, which can be an AC connector and which can connect to a device, such as a light, which is powered with AC power.

Another signal can be sent from the splitter to an AC adapter, which converts the AC signal to DC and then transmits the converted DC signal over a DC connector to a direct current powered device, such as any of the additional devices previously discussed herein.

Another signal is sent from the splitter to a Power Over Ethernet (PoE) converter. The PoE converter can convert the AC power signal received from the splitter into DC power and data packets. The PoE converter can then transmit data to and from a camera over an RJ-45 connector, which can be the communication connector. In this example, the communication interface is the interface of the PoE converter which is coupled to the RJ-45 connector and which transmits and receives data over the RJ-45 connector.

The data received from the camera over the RJ-45 connector can be received by the interface of the PoE converter which is coupled to the RJ-45 connector (the communication interface), converted back into an AC power signal by the PoE converter, and sent back to the splitter, which routes it to the power line over the power-line connector. Since the RJ-45 connector also allows for the transmission of power, DC power can also be transmitted from the PoE converter to the camera over the same RJ-45 connector.

Alternatively, as shown in FIG. 6B, the camera can be powered with DC power transmitted from the AC adapter over a DC connector, rather than DC power transmitted from the PoE converter over the RJ-45 connector. In this case, a second splitter can be used to split the output signal from the AC Adapter, or the AC adapter can have multiple outputs.

Of course, any of the connectors shown in FIGS. 6A-6B can also be part of the power-line adapter. For example, the power-line adapter can include the power-line connector, the AC power connector, the DC power connector, and/or the communication connector (such as the RJ-45 connector).

Additionally, if the only device being connected to the power line is a camera and the camera is powered by PoE, then the power interface and the communication interface can both be part of the PoE converter. In this case, the interface of the PoE converter which couples with the power-line connector would be the power interface and the interface of the PoE converter which couples with the communicator connector (such as an RJ-45 connector) would be the communication interface.

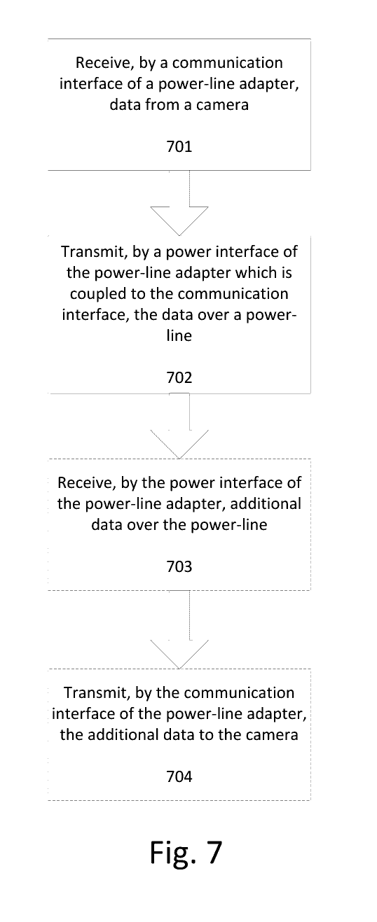

FIG. 7 illustrates a flowchart for a method of transmitting surveillance-related data over a power-line according to an exemplary embodiment. The method of FIG. 7 can be carried out using any combination of the components or devices discussed with regards to FIGS. 1-5 and 6A-6B.

At step 701, data from a camera is received by a communication interface of a power-line adapter. At step 702, the data is transmitted over a power line by a power interface of the power-line adapter which is coupled to the communication interface. At step 703, additional data is received over the power line by the power interface of the power-line adapter. At step 704, the additional data is transmitted to the camera by the communication interface of the power-line adapter.

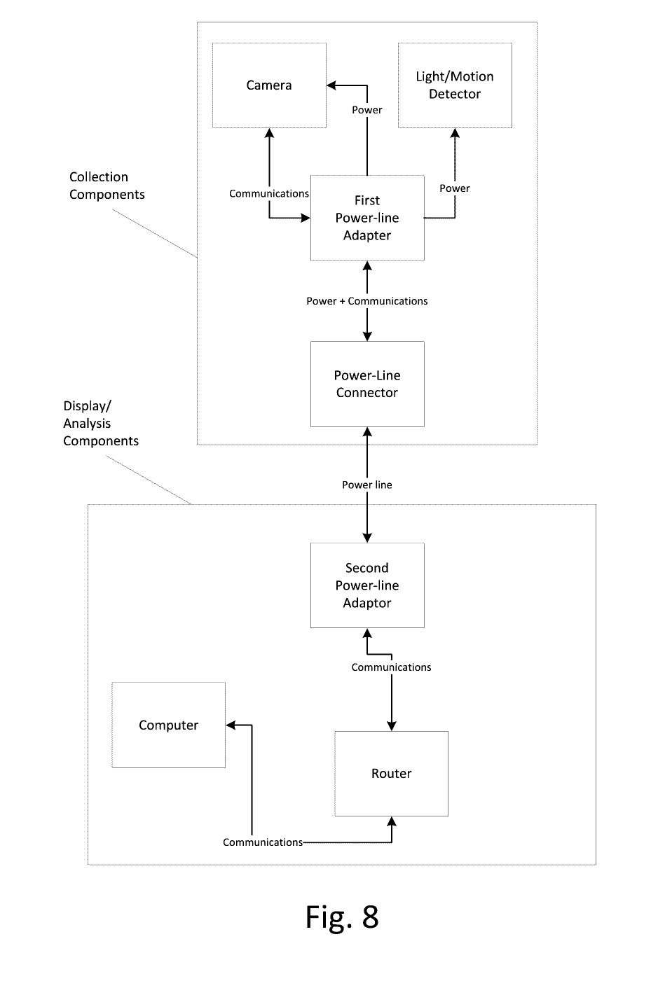

FIG. 8 illustrates a system chart showing collection components and display/analysis components according to an exemplary embodiment. As shown in the figure, data is transmitted from the first power-line adapter, through the power-line connector, and the over power line to a second power-line adapter which can be communicatively coupled to a router, which itself can be communicatively coupled to a computer, display device, or other device used for monitoring and inputting commands. The computer can also include software to provide control over the camera and/or any other devices coupled to the first power-line adapter. Additionally, data also flows in the opposite direction, from the computer to the router to the second power-line adapter over power line to the power-line connector and then the first power-line adapter.

The first power-line adapter provides bi-directional communications with the camera, and also provides power to the camera and to a light and/or a motion detector and can correspond to any of the power-line adapters previously described in this application (such as those shown in FIGS. 1, 4, and 5). The second power-line adapter need not be identical or even similar to the first power-line adapter. For example, the second power-line adapter can simply include an electrical connection and an Ethernet outlet for connecting to a router.

When some unwanted activity or potential intrusion is detected, either by the camera, the motion sensor or trigger, or by a computer which receives data from the camera and/or the additional devices, an alert sequence can be initiated. The alert sequence can include flashing of lights (such as those lights located near the camera) or audible alerts such as warnings, beeps, or sirens. The audible alerts can be transmitted via speakers connected to computing device or via one or more speakers which are integrated with the camera or otherwise connected to the first power-line adapter. The alert sequence can also trigger remote notifications to authorities, to a user or homeowner, or to an alarm company. Remote notifications can be transmitted over text message (SMS), email, or any other form of communication.

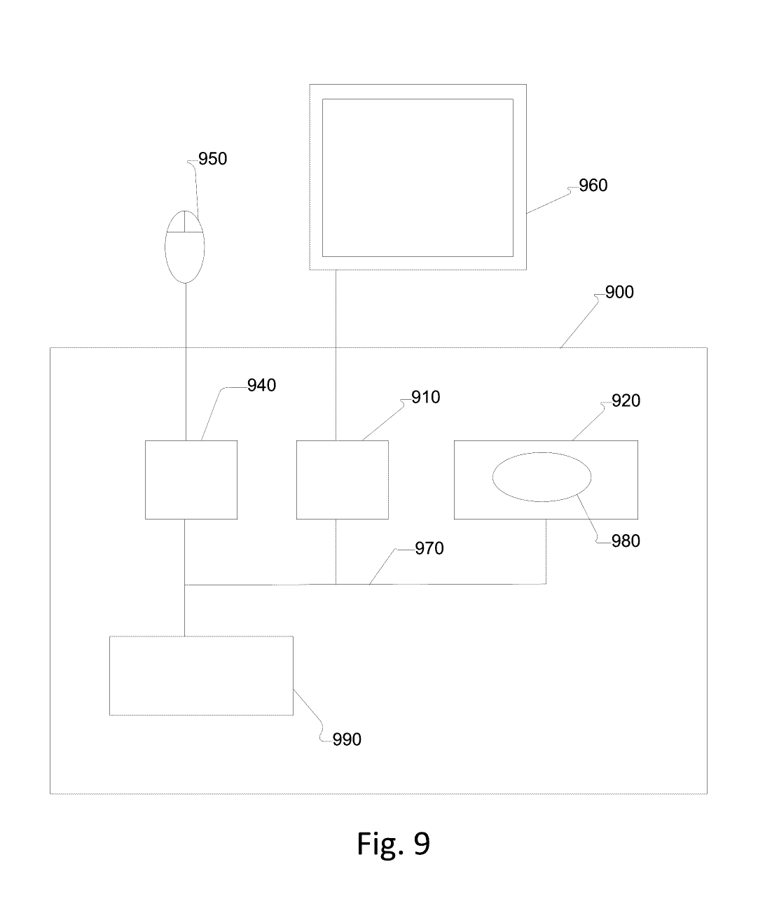

One or more of the above-described techniques can be implemented in or involve one or more computer systems. FIG. 9 illustrates a generalized example of a computing environment 900. The computing environment 900 is not intended to suggest any limitation as to scope of use or functionality of a described embodiment.

With reference to FIG. 9, the computing environment 900 includes at least one processing unit 910 and memory 920. The processing unit 910 executes computer-executable instructions and may be a real or a virtual processor. In a multi-processing system, multiple processing units execute computer-executable instructions to increase processing power. The memory 920 may be volatile memory (e.g., registers, cache, RAM), non-volatile memory (e.g., ROM, EEPROM, flash memory, etc.), or some combination of the two. The memory 920 may store software instructions 980 for implementing the described techniques when executed by one or more processors. Memory 920 can be one memory device or multiple memory devices.

A computing environment may have additional features. For example, the computing environment 900 includes storage 940, one or more input devices 950, one or more output devices 960, and one or more communication connections 990. An interconnection mechanism 970, such as a bus, controller, or network interconnects the components of the computing environment 900. Typically, operating system software or firmware (not shown) provides an operating environment for other software executing in the computing environment 900, and coordinates activities of the components of the computing environment 900.

The storage 940 may be removable or non-removable, and includes magnetic disks, magnetic tapes or cassettes, CD-ROMs, CD-RWs, DVDs, or any other medium which can be used to store information and which can be accessed within the computing environment 900. The storage 940 may store instructions for the software 980.

The input device(s) 950 may be a touch input device such as a keyboard, mouse, pen, trackball, touch screen, or game controller, a voice input device, a scanning device, a digital camera, remote control, or another device that provides input to the computing environment 900. The output device(s) 960 may be a display, television, monitor, printer, speaker, or another device that provides output from the computing environment 900.

The communication connection(s) 990 enable communication over a communication medium to another computing entity. The communication medium conveys information such as computer-executable instructions, audio or video information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

Implementations can be described in the general context of computer-readable media. Computer-readable media are any available media that can be accessed within a computing environment. By way of example, and not limitation, within the computing environment 900, computer-readable media include memory 920, storage 940, communication media, and combinations of any of the above.

Of course, FIG. 9 illustrates computing environment 900, display device 960, and input device 950 as separate devices for ease of identification only. Computing environment 900, display device 960, and input device 950 may be separate devices (e.g., a personal computer connected by wires to a monitor and mouse), may be integrated in a single device (e.g., a mobile device with a touch-display, such as a smartphone or a tablet), or any combination of devices (e.g., a computing device operatively coupled to a touch-screen display device, a plurality of computing devices attached to a single display device and input device, etc.). Computing environment 900 may be a set-top box, personal computer, or one or more servers, for example a farm of networked servers, a clustered server environment, or a cloud network of computing devices.

Having described and illustrated the principles of our invention with reference to the described embodiment, it will be recognized that the described embodiment can be modified in arrangement and detail without departing from such principles. It should be understood that the programs, processes, or methods described herein are not related or limited to any particular type of computing environment, unless indicated otherwise. Various types of general purpose or specialized computing environments may be used with or perform operations in accordance with the teachings described herein. Elements of the described embodiment shown in software may be implemented in hardware and vice versa.

In view of the many possible embodiments to which the principles of our invention may be applied, we claim as our invention all such embodiments as may come within the scope and spirit of the following claims and equivalents thereto.

What is claimed is:

1. A power-line adaptor comprising:
a communication interface configured to provide bidirectional communication with a camera via a communication connector; and
a power interface coupled to the communication interface and configured to connect to a power line via a power-line connector, wherein the power interface is further configured to transmit data received from the camera via the communication interface over the power line and to transmit data received over the power line to the camera via the communication interface.

2. The power-line adapter of claim 1, wherein the communication interface is further configured to provide power to the camera via the communication connector.

3. The power-line adapter of claim 2, wherein the communication connector comprises a power-over-ethernet connector.

4. The power-line adapter of claim 1, wherein the power-line connector comprises an Edison base.

5. The power-line adapter of claim 1, wherein the power-line connector comprises a two-wire connector.

6. The power-line adapter of claim 1, further comprising:
a passthrough coupled to the power interface and configured to provide power from the power line to one or more of the camera, a motion sensor, and a light.

7. The power-line adapter of claim 1, further comprising:
an alternating current adapter coupled to the power interface and configured to provide power to one or more of the camera, a motion sensor, and a light.

8. The power-line adapter of claim 1, further comprising:
a voltage adapter coupled to the power interface and configured to convert an input voltage associated with the power line to an output voltage, wherein the voltage adaptor is further configured to provide power at the output voltage to one or more of the camera, a light, and a motion sensor.

9. The power-line adapter of claim 1, wherein the data received from the camera comprises one or more of an image and a video.

10. The power-line adapter of claim 1, wherein the data received over the power line comprises one or more instructions for the camera.

11. A power-line apparatus comprising:
a camera communicatively coupled to a power-line adapter;
wherein the power-line adapter comprises a power interface configured to connect to a power line via a power-line connector and to transmit data received by the power-line adapter from the camera over the power line.

12. The power-line apparatus of claim 11, wherein the power interface is further configured to transmit data received by the power-line adapter over the power-line to the camera.

13. The power-line apparatus of claim 12, wherein the camera is communicatively coupled to the power-line adapter by a power-over-ethernet connector and wherein the power-over-ethernet connector is configured to provide power to the camera.

14. The power-line apparatus of claim 11, wherein the power-line connector comprises one of an Edison base or a two-wire connector.

15. The power-line apparatus of claim 11, wherein the power-line adapter further comprises:
a passthrough coupled to the power interface and configured to provide power from the power line to one or more of the camera, a motion sensor, and a light.

16. The power-line apparatus of claim 11, wherein the power-line adapter further comprises:
an alternating current adapter coupled to the power interface and configured to provide power to one or more of the camera, a motion sensor, and a light.

17. The power-line apparatus of claim 11, wherein the power-line adapter further comprises:
a voltage adapter coupled to the power interface and configured to convert an input voltage associated with the power line to an output voltage, wherein the voltage adaptor is further configured to provide power at the output voltage to one or more of the camera, a light, and a motion sensor.

18. The power-line apparatus of claim 12, wherein the data received by the power-line adapter from the camera comprises one or more of an image and a video and wherein the data received over the power line comprises one or more instructions for the camera.

19. A method of transmitting surveillance-related data over a power line, the method comprising:
receiving, by a communication interface of a power-line adapter, data from a camera; and
transmitting, by a power interface of the power-line adapter which is coupled to the communication interface, the data over a power line.

20. The method of claim 19, further comprising:
receiving, by the power interface of the power-line adapter, additional data over the power line; and
transmitting, by the communication interface of the power-line adapter, the additional data to the camera.
